(19) United States
(12) Patent Application Publication
(10) Pub. No.: US 2025/0373573 A1
(43) Pub. Date: Dec. 4, 2025

(54) SYSTEMS AND METHODS OF SAFETY INCIDENT MONITORING AND RESPONSE WITH ARTIFICIAL INTELLIGENCE

(71) Applicant: RapidSOS, Inc., New York, NY (US)

(72) Inventors: Martin Andres Minnoni, Pilar (AR); Ioannis Pazarzis, Woodhaven, NY (US); Carlos Emilio Sarraute Yamada, Escobar (AR)

(21) Appl. No.: 18/676,280

(22) Filed: May 28, 2024

(51) Int. Cl. H04L 51/02; G06F 3/0483; G06F 3/04842; G06F 40/20; H04L 51/043

(52) U.S. Cl. CPC H04L 51/02; G06F 3/04842; G06F 40/20; G06F 3/0483; H04L 51/043

(57) ABSTRACT

Systems and methods for facilitating electronic safety alert communications by a safety alert management system are disclosed herein. A method includes receiving an electronic safety alert for a specific safety event from a user electronic device via a safety alert application, the safety alert including at least one user message from a user associated with the user device. The method includes initiating an electronic chat session between the user and the safety agent attending the safety management application and, for at least one user message received at the safety management application, determining a reply message to send to the user device in response to the at least one user message. In embodiments, a machine learning model is used to analyze the user message and determine one or more recommended reply messages to display to the agent. A method for training a safety chat language model in a safety alert management system is also disclosed.

### TECHNICAL FIELD

This disclosure relates generally to safety monitoring and response systems, and specifically to systems and methods of electronic communication within safety monitoring and response systems.

### BACKGROUND

Emergency response and monitoring services are critically dependent on efficient, timely, and accurate communication. Monitoring stations, in particular, can play an important role in assessing and triaging calls. The staff at monitoring stations must often prioritize and respond to numerous calls or other communications concurrently, a task that demands rapid assessment, communication, and action.

It can be challenging to promptly respond to a high volume of incoming calls. Any bottleneck in response can lead to delays in the resolution of safety incidents. In the case of an emergency, there may be delays in the allocation of emergency responders to incidents, which can have serious repercussions on the outcome of emergency situations.

The response inefficiencies are often compounded by the difficulty of distinguishing between emergencies and non-emergencies, which can be time-consuming. Calls that do not warrant immediate emergency action must be identified to prevent the misallocation of critical resources. In addition, monitoring staff may have inconsistent, inefficient, or ineffective communication with callers that makes incidents more difficult to resolve in a short period of time. While some chat/messaging-based communication methods include a plurality of predefined scripts that a monitoring agent may select in response to messages from a caller, it remains time-consuming for the agent to narrow down the options to select a most applicable script from a large pool of predefined scripts devised to cover a variety of different situations. Thus, current monitoring systems lack sufficient support or tools for the monitoring staff to make swift assessments and provide effective communication when responding to incidents.

### BRIEF DESCRIPTION OF DRAWINGS

FIG. 1 is a schematic illustration of an exemplary alert response system, in accordance with some embodiments.

FIG. 2 is a schematic illustration of an exemplary user electronic device used in the alert response system of FIG. 1.

FIG. 3 is a schematic illustration of an exemplary alert management system used in the alert response system of FIG. 1.

FIG. 4 is a schematic illustration of an exemplary agent monitoring device used in the alert response system of FIG. 1.

FIG. 5 is a flow diagram of a method for facilitating electronic safety alert communications, in accordance with some embodiments.

FIG. 6 is a flow diagram of another method for facilitating electronic safety alert communications, in accordance with some embodiments.

FIG. 7 is a flow diagram of a method for training a safety chat language model in a safety alert management system, in accordance with some embodiments.

FIG. 8 is a flow diagram of a back-end process for determining reply messages in a safety chat, in accordance with some embodiments.

FIG. 9 is a view of a graphical user interface display of a safety response portal, in accordance with some embodiments.

FIG. 10 is an alternative view of the graphical user interface display of FIG. 9, in accordance with some embodiments.

FIG. 11 is an alternative view of the graphical user interface display of FIG. 9, in accordance with some embodiments.

### DETAILED DESCRIPTION

The systems and methods described herein include tools that facilitate electronic communication between a user (e.g., a person requesting incident assistance) and a monitoring agent to provide more efficient resolution of a safety incident. Specifically, the systems and methods herein employ artificial intelligence, such as machine learning models, within a safety management application and electronic chat interface to recommend a small pool of relevant reply messages to the monitoring agent for use in responding to user messages. Providing the AI-recommended reply messages to the monitoring agent not only results in more efficient and effective communication, but supports quick and accurate judging and decision-making of the monitoring agent with respect to how to respond to a safety incident described by the user. Further, in certain embodiments, the artificial intelligence model is configured to continuously improve its output over time by undergoing constant training on new communication sessions after they occur.

Systems and methods for facilitating electronic safety communications by a safety alert management system are described herein. In some embodiments, the method includes receiving an electronic safety alert for a specific safety event from a user electronic device. The safety alert, in embodiments, is received at a safety management application and typically includes at least one user message from a user associated with the user device. The alert may also include additional user data associated with the user.

In some approaches, the method includes initiating an electronic chat session between the user and a safety agent attending the safety management application, the chat session permitting exchange of at least text-based messages between the user and the safety agent and display of the text-based messages in a chat window of a graphical user interface accessible via the safety management application.

In illustrative embodiments, the method includes, for at least one user message received at the safety management application, determining a reply message to send to the user device in response to the at least one user message. In some forms, this includes, via an artificial intelligence engine associated with the safety management application, using a machine learning model trained on historical chat sessions and historical data associated with historical safety alerts to analyze the at least one user message and determine one or more recommended reply messages addressing a possible safety issue experienced by the user. In embodiments, at least one of the one or more recommended reply messages is determined by selecting at least one most relevant pre-determined reply message from a stored library of pre-determined reply messages related to various kinds of safety issues. In some approaches, the selection is based at least on the at least one user message (e.g., the last or most recent message). In some embodiments, the selection is based at least on an entire message history of the chat session and/or the user data.

In certain embodiments, determining a reply message to send to the user device includes, via an artificial intelligence engine associated with the safety management application, using a machine learning model, such as generative pretrained transformer (GPT), trained on historical chat sessions and historical data associated with historical safety alerts to analyze the at least one user message and determine one or more recommended reply messages addressing a possible safety issue experienced by the user. In embodiments, at least one of the recommended reply messages is a generated message generated by the GPT model. The generation may be based at least in part the at least one user message. In embodiments, the generation may be based at least in part on an entire message history of the chat session and/or the user data.

The method may further include displaying the one or more recommended reply messages on the graphical user interface. In embodiments, the method also includes receiving a selection indicating an agent-selected message from the safety agent, the agent-selected message including one of the one or more recommended reply messages. The agent-selected message may be transmitted in the chat session to the user.

Systems and methods for training a safety chat language model in a safety alert management system are also disclosed herein. In some embodiments, a method includes inputting at least one first set of training data including a plurality of text messages related to safety events into a safety chat language model and training the safety chat language model on the at least one first set to determine relevant reply messages addressing possible safety issues described in the text messages in response to the text messages. The method may further include receiving an electronic safety alert for a specific safety event from a user electronic device. In some examples, the safety alert is received at a safety management application and includes at least one user message from a user associated with the user electronic device and, in some embodiments, additional user data associated with the user.

The method may further include initiating an electronic chat session for the electronic safety alert between the user and a safety agent attending the safety management application and analyzing the at least one user message via the trained safety chat language model to determine one or more recommended reply messages. In embodiments, the determination may be based at least in part on the at least one user message. In some approaches, the determination is based at least in part on an entire message history of the chat session and/or the user data.

In some approaches, the method includes displaying the one or more recommended reply messages to the safety agent in a graphical user interface of the safety management application. The method may also include receiving a selection indicating an agent-selected message selected by the safety agent, the agent-selected message including one of the one or more recommended reply messages. In embodiments, a further step includes transmitting the agent-selected message to the user electronic device via the chat session.

In some approaches, the method includes associating the electronic safety alert, the entire history of the electronic chat session, the user data, the one or more recommended reply messages, and the transmitted agent-selected message via a unique alert ID to provide an associated second set of training data. The method may further include inputting the associated second set of training data into the safety chat language model and training the safety chat language model thereon.

Those skilled in the art understand that machine learning comprises a branch of artificial intelligence. Machine learning typically employs learning algorithms such as Bayesian networks, decision trees, nearest-neighbor approaches, and so forth, and the process may operate in a supervised or unsupervised manner as desired. Deep learning (also sometimes referred to as hierarchical learning, deep neural learning, or deep structured learning) is a subset of machine learning that employs networks capable of learning (typically supervised, in which the data consists of pairs (such as input data and labels) and the aim is to learn a mapping between the input_data and the associated labels) from data that may at least initially be unstructured and/or unlabeled. Deep learning architectures include deep neural networks, deep belief networks, recurrent neural networks, and convolutional neural networks. Many machine learning algorithms build a so-called “model” based on sample data, known as training data or a training corpus, in order to make predictions or decisions without being explicitly programmed to do so. A variety of different methodologies and models may be employed with these teachings, such as those discussed below.

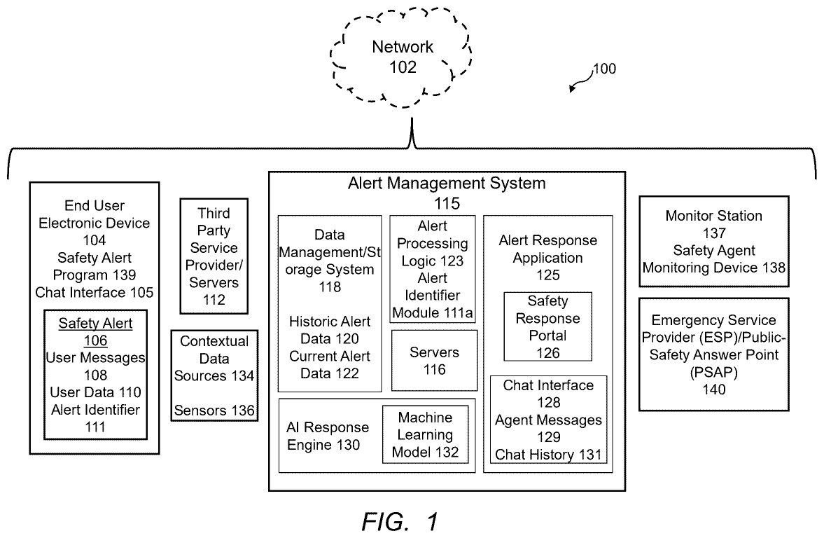

With reference to FIG. 1, an embodiment of an alert response system (ARS) 100 for responding to safety alerts 106 is shown. The alert response system 100 includes, at least, one or more end user electronic devices 104, an alert management system (AMS) 115 for managing and responding to safety alerts 106, and one or more agent monitoring devices 138 communicatively coupled via a network 102. The system may further include one or more third party servers 112 that process safety alerts 106 generated at the user electronic devices 104 prior to transmitting the safety alerts 106 to the AMS 115. For instance, in some embodiments a safety alert 106 is generated at a user electronic device 104 via a third-party application, platform, or service such that the third party servers 112 communicate the safety alert 106 to the AMS 115. Advantageously, this configuration permits a centralized AMS 115 to be employed in a variety of different third party applications.

The system components may be communicatively coupled, either directly or indirectly, such as over one or more distributed communication networks 102, which may include, for example, LAN, WAN, Internet, Wi-Fi, and other such communication networks or combinations of two or more of such networks.

In embodiments, the ARS 100 further includes a monitoring station 137 that includes the agent monitoring devices 138 and safety agent staff. In some approaches, the ARS 100 further includes emergency service providers (ESP) 140 such as, for example, public-safety answer points (PSAP) or emergency discharge centers. In certain embodiments, the monitoring station 137 may communicate with the ESP 140 to request or coordinate a further emergency response to the safety alert 106. In some approaches, the ESP 140 itself includes the functions attributed herein to the monitoring station 137 (e.g., the monitoring functions described herein are integrated within an ESP or PSAP).

The system 100 may also include contextual data sources 134 which may provide further contextual information to the AMS 115 for responding to safety alerts 106. For instance, in some embodiments the contextual data sources may, for example, provide sensor data, camera data, emergency call data, medical/health data, law enforcement data, weather data, demographic data, multimedia or news data (e.g., from news feeds), and/or geolocation data. In embodiments, the contextual information includes historical data and/or real-time data. In some embodiments, the contextual data sources 134 include sensors 136 that provide real-time sense data to the AMS. By some approaches, the sensors 136 are associated with the user electronic device 104 or with the user that generates the safety alert 106 and provide specific information to be analyzed along with the safety alert 106. The sensors 136 may provide physiological sensor data, environmental sensor data, or both. In some embodiments, physiological sensor data comprises heart rate, blood oxygen level, blood carbon dioxide level, blood pressure, blood sugar level, body temperature, respiration rate, physical activity, or any combination thereof. In some embodiments, the environmental sensor data comprises light, motion, temperature, pressure, humidity, vibration, magnetic field, sound, smoke, carbon monoxide, radiation, hazardous chemicals, acid, base, reactive compounds, volatile organic compounds, smog, or any combination thereof. In some embodiments, the sensor data is compiled from at least one sensor associated with an automatic alarm. In some embodiments, the at least one sensor comprises a gyroscope, an accelerometer, a thermometer, a heart rate sensor, a barometer, a hematology analyzer, a motion sensor, or any combination thereof. In some embodiments, the at least one sensor comprises a motion sensor, a window or door sensor, a security camera, a glass break detector, or any combination thereof. Other sensors may include, for example, location sensors (e.g., GPS), image sensors (e.g., camera/video), audio sensors, fall detection sensors, vehicle crash detection sensors, etc. In some embodiments, the AMS 115 requests contextual or sensor data from one or more of the data sources 134 or sensors 136. For instance, in one approach, a data request is a geospatial query manually submitted through a graphical user interface (GUI) of the alert response application 125, using, for example, an interactive map. The requested data may include data from available sensors or data sources within a radius defined by the geospatial query. The requested and collected data may be associated with the specific safety alert 106 via a unique alert identifier 111 of the safety alert 106. In some embodiments, the data request is automatically transmitted from the AMS in response to the AMS detecting a safety alert 106 received by the monitoring station 137.

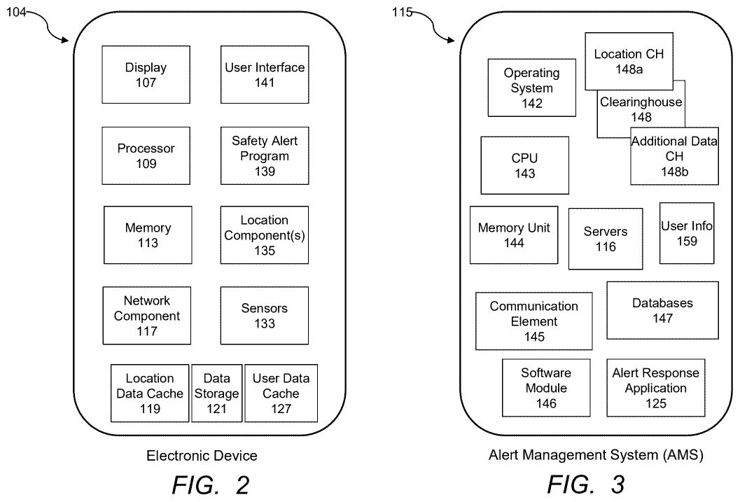

With reference to FIG. 1 and FIG. 2, the user electronic device 104 (e.g., a device associated with a user and used to initiate a safety alert 106) is a digital processing device such as a communication device, e.g., a mobile or cellular phone such as a smart phone, a tablet, computer, laptop, etc. In some embodiments, the electronic device is a portable or wearable device (e.g., a smartwatch). In some embodiments, the electronic device is an Internet of Things (IoT) device, such as a home assistant (e.g., an Amazon Echo) or a connected smoke detector (e.g., a Nest Protect smoke and carbon monoxide alarm). In some embodiments, more than one electronic device is used to coordinate transmission of a safety alert to the AMS 115. In illustrative embodiments, at least one of the electronic devices 104 includes a user interface 141 configured to permit text-based electronic messaging/chat communication related to the safety alert.

In exemplary embodiments, the electronic device 104 includes a display 107, a processor 109, a memory 113 (e.g., an EPROM memory, a RAM, or a solid-state memory), a network component 117 (e.g., an antenna and associated components, Wi-Fi adapters, Bluetooth adapters, etc.), a data storage 121, a user interface 141, a safety alert program or module 139, one or more location components 135 (e.g., GPS), and one or more sensors 133. In some embodiments, the processor 109 is implemented as one or more microprocessors, microcomputers, microcontrollers, digital signal processors, central processing units, state machines, logic circuitries, and/or devices that manipulate signals based on operational instructions. Among other capabilities, the processor 109 is configured to fetch and execute computer-readable instructions stored in the memory 113.

In some embodiments, the display 107 is part of the user interface 141 (e.g., a touchscreen is both a display and a user interface in that it provides an interface to receive user input or user interactions and provides a visual output of information). In some embodiments, the user interface 141 includes physical buttons such as an on/off button or volume buttons. In some embodiments, the display 107 and/or the user interface 141 comprises a touchscreen (e.g., a capacitive touchscreen), which is capable of displaying information and receiving user input. In some embodiments, the device 104 includes various accessories that allow for additional functionality. In some embodiments, these accessories (not shown) include one or more of the following: a microphone, a camera, speaker, a fingerprint scanner, health or environmental sensors, a USB or micro-USB port, a headphone jack, a card reader, a SIM card slot, or any combination thereof. In some embodiments, the one or more sensors 133 include, but are not limited to: a gyroscope, an accelerometer, a thermometer, a heart rate sensor, a barometer, or a hematology analyzer. In some embodiments, the data storage 121 includes a location data cache 119 and a user data cache 121. In some embodiments, the location data cache 119 is configured to store locations generated by the one or more location components 135. In some approaches, these accessories and/or sensors may be located within the device 104 or coupled thereto. For instance, in some examples, devices such as a smartwatch or heart rate monitor may transmit sensed data to the user device 104 (e.g., through Bluetooth or other suitable wireless connections).

In some embodiments, the safety alert program 139 is part of an application or mobile application of the electronic device 104. The safety alert program 139 is configured to facilitate a user's generation of an electronic safety alert 106 or request for assistance to the AMS 115. The safety alert program 139 may include a communication or chat interface 105 to enable a two-way text-based chat session. The communication interface may also permit voice exchange or exchange of other media (e.g., photos, videos, etc.). The safety alert program 139 is also configured to record user data 110, such as a name, address, phone number, or medical data of a user associated with the electronic device 104, or a current location of the electronic device 104.

In some approaches, the safety alert program 139 is not a separate application but rather is integrated as a safety feature within an application or mobile application (e.g., a third party application) that serves a broader or separate purpose. For instance, in one illustrative embodiment, a rideshare application, used to connect riders desiring to travel to specific locations with drivers, includes a safety alert feature that the rider or driver may use when a safety incident occurs during the rideshare. For instance, the rideshare application may display a button that the rider or driver may press to initiate a safety alert 106. In embodiments, pressing the button opens the communication interface 105 for the safety alert chat session. In some examples, the safety alert program 139 may integrate data, features, and functionality of the AMS 115 via an Application Programming Interface (API) or API plug-in.

The safety alert program 139 is configured to deliver the safety alert 106 to the AMS 115. In some embodiments, the transmission is an HTTP post containing information associated with the safety alert 106. In some embodiments, the safety alert 106 includes, at least, an alert notification. The safety alert 106 may include one or more user messages 108 (e.g., text-based messages or multimedia messages input by the user in the chat interface 105) transmitted by the user via the safety alert chat interface 105. The safety alert 106 may also include a location (e.g., a device-based hybrid location) generated by or for the electronic device 104. In some embodiments, the safety alert program 139 is configured to deliver user data 110 to the AMS 115. The safety alert 106 may be assigned a unique alert identifier 111 (e.g., through an alert identifier module 111a of the AMS 115 which assigns and tracks the safety alerts 106 via the alert identifier 111). In embodiments, the alert identifier 111 may be associated with any and/or all of the information contained in the safety alert (e.g., chat messages, user data, sensor data, logistical information (date, time, location of alert), etc.). Specifically, the alert identifier tracks all data payloads that belong to the same alert incident, ensuring that all pieces of information related to a specific incident can be correlated and managed effectively.

For instance, in some embodiments, a main use of the alert identifier is to track and correlate all data points related to a single alert incident. This ensures that all relevant information is grouped together, providing a complete picture of the incident. The alert identifier may also facilitate data integration. When multiple systems or platforms are involved in handling alert data, the alert identifier allows for seamless integration and correlation of data across these systems. This is particularly important for maintaining consistency and accuracy in incident reporting and response. In some approaches, the alert identifier may also facilitate integration of incident insights. In embodiments where the AMS 115 may generate insights, findings, or new data (e.g., analytical data) associated with the incident, the alert identifier allows these insights to be linked back to the original alert. This ensures that all analytical outputs and insights are tied to the correct incident, facilitating better decision-making and response strategies.

In some approaches, the alert identifier 111 may be system-generated at the source of the alert. That is, the system that is the initial source of the alert (such as a third party service provider or device) generates a unique identifier to ensure all related data points are linked to the same incident. In other approaches, the system that receives the alert data (e.g., the AMS 115) generates the alert identifier 111, creating its own ID to track information associated with the incident.

With reference to FIGS. 1 and 3, in some embodiments, the alert management system (AMS) 115 includes an operating system 142, a CPU 143, a memory unit 144, a communication element 145, and one or more software modules 146. The CPU 143 may be implemented as one or more microprocessors, microcomputers, microcontrollers, digital signal processors, central processing units, state machines, logic circuitries, and/or devices that manipulate signals based on operational instructions. Among other capabilities, the CPU 143 is configured to fetch and execute computer-readable instructions stored in the memory unit 144. The memory unit 144 optionally includes any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory unit 144 optionally includes modules, routines, programs, objects, components, data structures, etc., which perform particular tasks or implement particular abstract data types.

In some embodiments, the AMS 115 includes one or more databases 147, one or more servers 116, and a clearinghouse 148. In some embodiments, the clearinghouse 148 is an input/output (I/O) interface configured to manage communications and data transfers to and from the AMS 115 and external systems and devices. In some embodiments, the clearinghouse 148 includes a variety of software and hardware interfaces, for example, a web interface, a graphical user interface (GUI), and the like. The clearinghouse 148 optionally enables the AMS 115 to communicate with other computing devices, such as web servers and external or third party data servers. In some embodiments, the clearinghouse 148 facilitates multiple communications within a wide variety of networks and protocol types, including wired networks, for example, LAN, cable, etc., and wireless networks, such as WLAN, cellular, or satellite. In some embodiments, the clearinghouse 148 includes one or more ports for connecting a number of devices to one another or to another server. In some embodiments, the clearinghouse 148 includes one or more sub-clearinghouses, such as location clearinghouse 148a and additional data clearinghouse 148b, configured to manage the transfer of locations and additional data, respectively. The clearinghouse 148 may include further features and functionality as described, for example, in U.S. Pat. No. 11,902,871, the contents of which are incorporated by reference herein in its entirety.

The databases 147 may define a portion of a data management and storage system 118 of the AMS 115. The data system 118 may store, for example, historic alert data 120 and current alert data 122. In some embodiments, the historic alert data 120 and current alert data 122 are associated with specific alert identifiers 111. The historic alert data 120 and current alert data 122 may be available for future analytics as well as for training of the machine learning model (described further below). The data system 118 may also store other data, for example the data from contextual data sources 134 and the user data 110 described above. The AMS further may further store alert processing logic, programming,or software 123 to process the alerts 106.

In some embodiments, the AMS 115 may include a user information module 159 that receives and stores user information (e.g., personal information, demographic information, medical information, location information, etc.) within the AMS 115. In some embodiments, users can submit user information through a website, web application, or mobile application, such as during a registration process for an alert response application or during a registration process for a third party service associated with the AMS 115. In some embodiments, when the AMS 115 receives safety alert data including user information (which may be first received by the clearinghouse 148), the AMS 115 stores the user information in the user information module 168. In some embodiments, user information stored within the user information module 168 is received by the AMS 115 from a third-party server system. In some embodiments, user information stored within the user information module 168 is associated with an identifier of a user or an electronic device associated with a user, such as a phone number, username, and/or email address.

The AMS 115 may also include an alert response application 125. In some embodiments, data and information is shared between the AMS 115 and the monitoring center 137 through the alert response application 125. In illustrative embodiments, the alert response application 125 may be used to facilitate communications between the monitoring center 137 and the user (e.g., a person requesting assistance). In some embodiments, it may also be used to facilitate communications between the monitoring center 137 and one or more ESPs/PSAPs. In some approaches, the alert response application 125 is a software application either installed on a computing device 138 at the monitoring center 137 or accessed via the internet through a web browser on the computing device (e.g., the alert response application is hosted on a cloud computing system by the AMS). Generally, the alert response application 125 may function to both facilitate communication links between the user, AMS, monitoring center, and ESP and provide access to alert-related data. The alert response application 125 optionally includes various components, such as a frontend application or graphical user interface, for example, accessed via safety response portal 126, a backend application, an authorization module, a user database, and additional features described below. Any or all of the components of the alert response application 125 may be hosted on a cloud computing system by the AMS, a computing device at the monitoring center 137 or at an ESP/PSAP, or some combination thereof.

In some embodiments, the alert response application 125 is a webpage or web application that can be accessed through an internet or web browser. In such embodiments, the alert response application 125 can be quickly and easily integrated into the systems used by third-party monitoring stations 137 or emergency service providers (ESPs), such as public safety answering points (PSAPs), because accessing and using the alert response application 125 requires no additional software or hardware outside of standard computing devices and networks. However, in some embodiments, the alert response application 125 is a software application installed on a computing device. The alert response application 125, in illustrative embodiments, may be provided by the AMS or may be provided by a third party.

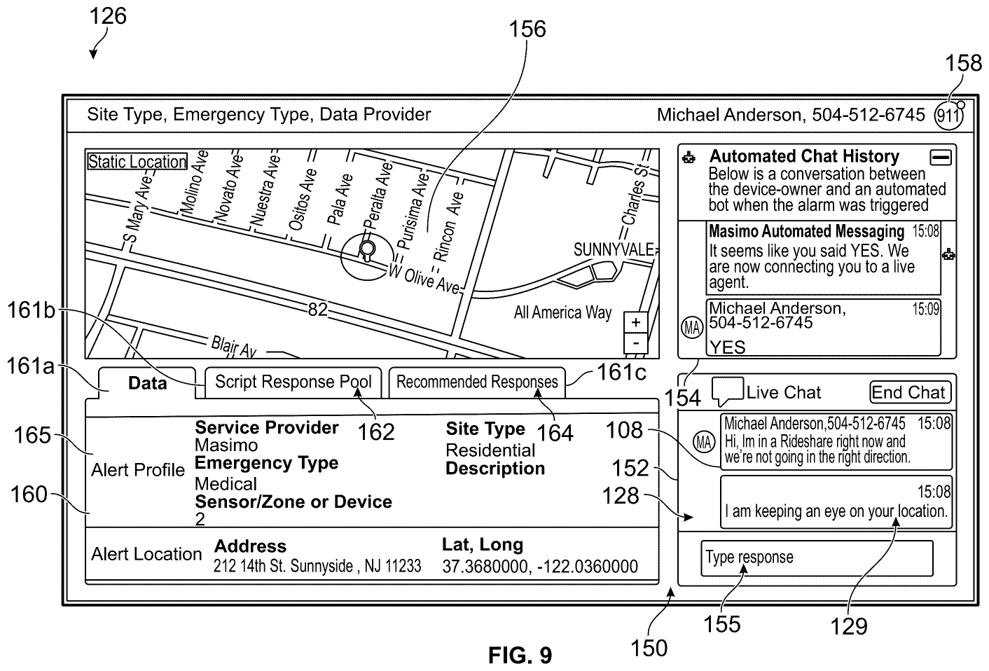

With reference to FIG. 9, the graphical user interface 150 of the safety response portal 126 permits a monitoring agent to manage and respond to a safety alert 106. In one approach, the graphical user interface includes a safety alert mode configured to show various details of one safety alert 106 at a time. In this mode, the graphical user interface may be divided into several screen portions. One portion may be an interactive map portion 156, which, for example, displays a map showing a location of the safety alert 106, and, in some embodiments, provides real-time or continuous tracking of an electronic user device 104 associated with the alert 106. For instance, in some approaches, as a user moves and a new location is received, previous locations will appear as pins (breadcrumbs) and the most recent location will show up as a larger pin.

The GUI may further include a safety chat portion 128 for communicating with the user requesting assistance. The chat function may use any real-time messaging protocol known in the art, for example, SMS, MMS, HTTP/HTTPS, XMPP, MQTT, WebRTC, WebSocket, etc. A monitoring agent may enter agent messages 129 into the chat 128 via a chat input portion 155 to, for example, respond to the user messages received in the safety alert 106. In some embodiments, there may be an automated chat window 154 and a non-automated or “live” chat window 152. The automated chat window 154 may include any automated chat history (e.g., in an autonomous chat session) that occurs between the user and an automated bot when the safety alert 106 is first triggered, before the safety alert 106 is transferred to the live monitoring agent and messaging takes place via the non-automated chat window 152. The automated bot may be an artificial conversational entity that can communicate with a user according to a predetermined script or completely independently using any appropriate form of artificial intelligence, such as deep learning or natural language processing, including via the artificial intelligence response engine 130 and machine learning model 132 of the AMS 115 described further below. In some embodiments, a chatbot communicates with a user of an electronic device by posing questions to the user to gather emergency data or information. The automated bot may, for example, be configured to present screening questions and receive user input, for example, confirming the user's request for assistance, a type of incident, an urgency of the incident, a location of the incident, etc. In some embodiments, the automated bot may request additional information. In some embodiments, the chat poses yes-or-no questions to the user of the electronic device. In some embodiments, the chat poses multiple choice questions to the user of the electronic device. In some embodiments, the chatbot poses free response questions to the user of the electronic device. In certain embodiments, one or more user-provided answers or confirmation provided to the bot is necessary before the live chat is initiated.

In certain approaches, the safety chat 128 enables sending not only text-based chat messages but also images, audio clips, videos, live video streams, and/or other media. In some embodiments, the user may send these files in the chat. Alternatively or additionally, these types of files may be automatically sent by the service providers to, for example, provide verification of an incident.

Advantageously, the safety chat 128 can be used in situations, for example, where the end user needs to remain discreet in moments when they feel unsafe, when the user is feeling unsafe and cannot connect with emergency services directly, when the user is not sure if the situation is going to escalate to the point of needing emergency services, or when the end user prefers the option to message rather than call an agent.

In some embodiments, the graphical user interface includes an escalation or emergency dispatch button 158 so the agent can access options to initiate an emergency response (e.g., law enforcement, medical services, emergency services, etc.) to a location of the safety alert 106. In some embodiments, the initiation of an emergency response includes digital transmission of the information associated with the safety alert 106 to an ESP or PSAP.

In some approaches, the graphical user interface may include one or more content portions 165 that contain, for instance, a data card 160 that provides information about the safety alert 106, such as, for example, the service provider for the alert (e.g., a third-party service), a type of incident or emergency, an alert location (e.g., address and/or geolocation), device information, sensor information, zone information, user information (e.g., name, phone number, medical conditions, medications), and/or a description of the alert 106. In some embodiments, the information shown may depend on the type of service provider for the alert and/or type of incident. For instance, for a rideshare service, the information may include a car make, model, and license plate, and driver and/or passenger details. For a home security service, the information may include, for example, sensor information, family and house information, gate code information, an alarm permit number, etc. By way of another example, for a university-related alert, the information may include, e.g., a building, floor, and a dorm room number.

In some embodiments, the one or more content portions 165 may also include message scripts that the agent may select to input into the chat in response to a user message when appropriate. In some approaches, the message scripts may be separated into a pool of script responses 162 and a narrower selection of recommended reply messages 164. In embodiments, the script response pool 162 has the same content during a specific alert 106, while the recommended reply messages 164 may change depending on the most recent user message or based on new information received with respect to the safety alert 106. In certain embodiments, the contents of the script response pool 162 may be different for different safety alerts 106 depending on the type of safety issue (e.g., the pool 162 may be tailored to a certain category of incident), along with other variables. For example, in some embodiments, the content of the script response pool 162 displayed for the safety alert 106 varies depending on the service (e.g., a third party provider) that is the source of the alert. That is, different third party services or providers may have a script response pool 162 specifically tailored to certain types of alerts.

In some approaches, the pool of script responses 162 displayed in the safety portal 128 may be configured to change in real-time over the course of an alert 106, for instance if the system re-categorizes the incident based on new information, during different phases of the alert 106 or chat (e.g., an initial phase, a phase in which physical assistance has been requested, a resolution phase, etc.) or if new scripted responses are submitted into the system during the alert. In some approaches, artificial intelligence (e.g., artificial intelligence engine 130) or other logic may be used to vary or change the pool of script responses 162, based, for example, on analysis of the safety chat messages and/or other information associated with the safety alert 106.

In some non-limiting embodiments, a content portion 165 includes a plurality of selectable tabs to view different content. For instance, as illustrated, there may be a first tab 161a with the data card 160, a second tab 161b containing the script response pool 162, and a third tab 161c containing the recommended reply messages 164.

The script response pool 162 may include a plurality of different script messages 163 that constitute typical and relevant possible responses to user messages. The agent may select the most applicable script message to send in the chat. For instance, each script may have a “send” or “copy to chat” button 168. By one approach, when the selected script is copied to the chat it is copied into the input portion 155 of the chat 128 so the agent has the option to edit the script before sending. In some approaches, each message may alternatively or additionally have a button that transmits the response directly into the chat without the option to edit (such as a “send” button), which can save time.

The script response pool 162, in embodiments, includes a wide range of predetermined responses. For instance, the pool may include a selection of initial or first responses that respond to the initial request for assistance. The pool may include a selection of possible second or follow-up responses that, for example, confirm the agent's continued monitoring. The pool may include a selection of possible responses that pertain to a user's request for emergency assistance and a selection of possible responses that pertain to a status of the requested emergency assistance (e.g., police are arriving at the scene). The pool may include a selection of questions to further determine the risk involved in the situation, verify information related to the safety alert, and/or request a status of the incident. The pool may include a selection of questions related to concluding the chat when the safety alert 106 has been resolved. The number and types of possible script responses is not particularly limited. The pool also may include potential recommended actions or instructions.

In some approaches, the received message 163 includes a subject or header portion 163a which indicates a type, category, or brief descriptor of the response message (e.g., “Assistance Needed (First Response)”, “Emergency Assistance Needed”, “Emergency Assistance Arrived on Scene”, etc.) and a message portion 163a that contains the content of the response message. The header portions 163a may help the agent to quickly scan or review the pool of messages to find response messages that are most applicable to the last user message or current situation.

In some embodiments, there may be one or more recommended reply messages 164, which may be ranked or displayed based on a number of factors. Advantageously, the AMS is configured to provide the one or more recommended reply messages 164 to facilitate a quicker response to the user. Specifically, the recommended reply messages 164 may allow the agent to select a message from a significantly smaller selection of messages tailored to the specifics of the user message and the current situation without having to scan the entire script response pool 162 to find a most applicable response. Like with the script messages 163 in the pool 162, the recommended reply messages 164 may include a subject or header portion 164a and a message portion 164b. In some approaches, the header portion 164a may indicate whether the recommended reply message 164 is a recommended script reply message 166 (i.e., a recommended script selected out of the script response pool 162 or out of a larger library of script responses stored in the AMS) or a recommended generated response 167 (e.g., an AI-generated response).

As explained in further detail below, the recommended reply messages 164 are typically determined via an artificial intelligence (AI) response engine 130 of the AMS. Upon receipt of a new user message, the artificial intelligence response engine 130 analyzes the user message and outputs the one or more recommended reply messages 164 to the alert response application 125. The AI response engine 130 may include one or more machine learning models 132 including one or more machine learning algorithms to carry out these functions. In some embodiments, the machine learning model 132 may include any suitable model trained to output computer-generated text in response to prompts (e.g., text, image, audio, video, data). In some embodiments, the machine learning model 132 may include an end-to-end, artificial neural network.

In one approach, the machine learning model 132 is a natural language processing model selected from recurrent neural networks, long short-term memory networks, and transformer models. Natural language processing and/or natural language understanding may be implemented to determine the literal and/or intended meaning of user messages. For instance, user messages may be parsed to determine the type of incident, the urgency of the incident, the location of the incident, etc. In one approach, the machine learning model 132 includes a transformer-based language model. In some implementations, the machine learning model 132 is configured to use self-attention. The generative pre-trained transformer GPT-1, GPT-2, and GPT-3 models are non-limiting examples of suitable transformer-based language models that use self-attention. In some embodiments, Bidirectional Encoder Representations from Transformers (BERT) may be used.

In some embodiments, the machine learning model 132 generates, determines and outputs a plurality of recommended reply messages 164, for example, at least two, at least three, at least four, or at least five messages. In one example, three recommended reply messages are output. In certain approaches, a maximum amount of recommended reply messages 164 output in response to a user message may be six. The number of output recommended reply messages may be selected to strike a balance between providing different options to the agent to ensure precision while not being too time-consuming to review.

As explained further below, in some approaches the recommended reply messages 164 output by the AI response engine 130 are recommended script reply message 166, where the AI response engine 130 is configured to select one or more recommended script reply messages 166 out of the script response pool 162 or out of a larger library of script responses stored in the AMS. Alternatively or additionally, the recommended reply messages 164 output by the AI response engine 130 are recommended generated reply messages 167, where the AI response engine 130, using a trained generative language model, is configured to generate one or more new responses (i.e., not scripted) in response to the user message. In some approaches, the AI response engine 130 outputs only recommended script reply messages 166 or only recommended generated reply messages 167, while in other approaches the AI response engine 130 outputs at least one recommended script reply message 166 and at least one recommended generated reply message 167. In the latter approach, the user interface may distinguish between the recommended script reply messages 166 and the recommended generated reply messages 167 by labelling them as such (e.g., in the subject/header portion 164a), by using a different color or other visual indicia, and/or by a spatial separation (e.g., in a different column or tab). In some approaches, the AI response engine 130 determines whether to output one or more recommended script reply messages 166, one or more recommended generated reply messages 167, or both. In some embodiments, the AI response engine 130 determines at least one recommended reply message 164, where there may be 0 to 5 recommended script reply messages 166 and 0 to 5 recommended generated reply messages 167.

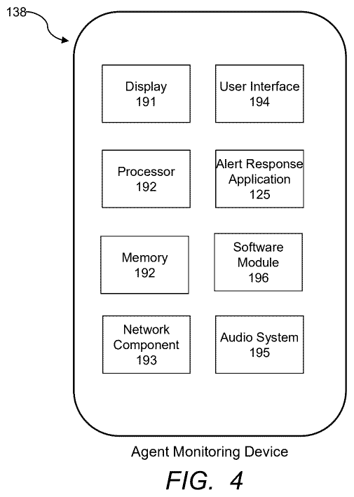

With reference to FIGS. 1 and 4, in some embodiments a safety agent monitoring device 138 (e.g., associated with a monitoring center 137 or with an emergency service provider (ESP) system 140 (e.g., a public safety answering point (PSAP)) includes one or more of a display 191, a user interface 194, at least one central processing unit or processor 192, a memory, 192, a network component 193, an audio system 195 (e.g., microphone, speaker and/or a call-taking headset), and a computer program such as an alert response application 125 for accessing, monitoring, and carrying out the functions of the Safety Response Portal 126 described above. In some embodiments, the application or program 125 includes one or more software modules 196 to operate the features described herein. In some embodiments, the agent monitoring device 138 or the application 125 includes a database of responders, such as medical assets, police assets, fire response assets, rescue assets, safety assets, etc. Such assets can be non-human assets such as, for example, autonomous drones or automated devices, though personnel also may be dispatched.

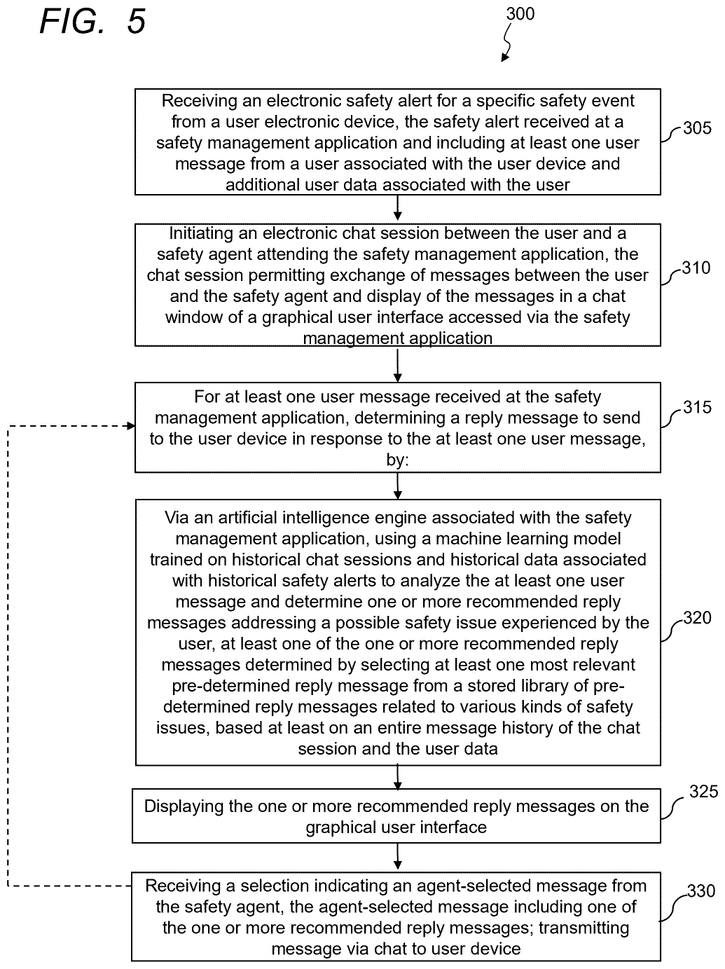

FIG. 5 shows an exemplary method 300 for facilitating electronic safety alert communications by a safety alert management system (AMS) (e.g., such as alert management system 115). With reference to FIGS. 1 and 5, the method includes, at block 305, receiving an electronic safety alert 106 for a specific safety event from a user electronic device 104 at the AMS 115. The user electronic device 104 may be any of the user devices described above, for instance, a mobile phone. As described above, the safety alert 106 may be transmitted using a safety alert program 139 on or accessed via the user electronic device 104, and may be transmitted directly to the AMS 115 or indirectly to the AMS 115 via servers of a third party service provider 112. In some embodiments, the safety alert program 139 may include a communication or chat interface 105 to enable a two-way text-based chat session in substantially real time.

In embodiments, the safety alert 106 transmitted to the AMS 115 includes at least one user message 108 (e.g., a text-based message) from a user associated with the user electronic device. The user messages 108 may be input by the user via the chat interface 105. The safety alert 106 may also include a notification that assistance is needed. In some embodiments, the notification may include at least one of a type of incident, location of the incident, and urgency of the incident. This information may be input by the user using the safety alert program 139 freely or in response to form prompts or automated bot prompts, and may be input prior to initiating the safety alert or after initiating the safety alert. The safety alert 106 may also include additional information or data, such as user data associated with the user (e.g., name, phone number, medical history), geolocation data (e.g., current GPS location of the device), and any associated sensor data. Upon receipt of the safety alert 106, the AMS 115 may also query internal data sources and/or external data sources 134 and/or sensors 136 that, for instance, may be associated with a location of the incident, with the user, or with the user electronic device to attain additional contextual information.

At block 310, the method 300 includes initiating an electronic chat session between the user and a safety agent attending a safety management application or safety alert response application 125 of the alert management system 115. For instance, as noted above, the safety alert response application 125 may be accessed via a monitoring device 138 of the agent, at or associated with, for example, a central monitoring station or service 137. The task of the safety agent may be to monitor, triage, respond to, and/or resolve safety alerts 106 when they are received by the system 115. The safety agent may further have the task of escalating safety alerts 106 if necessary by requesting assistance from first responders or other emergency personnel.

As described above, the electronic chat session may be displayed in a safety chat interface or chat portion 128 of the graphical user interface of the alert response application 125 accessed at the monitoring device 138. The chat session permits exchange of at least text-based messages between the user and the agent and display of the messages in the chat portion 128 of the graphical user interface. In some embodiments, the chat session permits exchange of other media such as images, video (e.g., including live stream video), audio, etc.). The additional information or data associated with the safety alert 106 may also be displayed on the graphical user interface for the agent's reference, as described above.

At block 315, the method 300 includes, for at least one user message received at the alert response application 125, determining a reply message to send to the user device in response to the at least one user message. In certain situations, an agent may simply independently respond to the user message by freely inputting a reply message into the chat interface 128. In addition, an agent may select an appropriate script response message 163 from a script response pool 162 displayed in a portion of the graphical user interface. However, advantageously, the alert response application 125 may additionally employ artificial intelligence to provide a select number of recommended reply messages 164 to assist the agent in determining a reply message. Specifically, in embodiments, the alert response application 125 interacts with an artificial intelligence response engine 130 that includes one or more machine learning models 132, as described above. Thus, for at least one user message received at the alert response application 125, determining a reply message to send to the user device in response to the user message may include the steps at blocks 320, 325, and 330.

Specifically, at block 320, the method 300 includes, via the artificial intelligence response engine 130, using a machine learning model 132 to parse and analyze the at least one user message 108 and determine one or more recommended reply messages addressing a possible safety issue experienced by or described by the user. In embodiments, the machine learning model 132 is trained, at least, on historical or prior safety alerts 106, for example on historical safety alert chat sessions and historical data associated with the historical safety alerts 106. In embodiments, the historical data associated with the historical safety alerts 106 includes any of the above-described types of information or data received with specific safety alerts 106 or that becomes associated with specific safety alerts 106, for instance, user information, logistical information (e.g., date and time), device information, location information, contextual or environmental data, sensor data, image or video data, incident data (e.g., category, description, urgency level), and resolution data (e.g., category or description of how the alert was resolved). In some approaches, the data includes evaluative or feedback information from the user or the agent (e.g., feedback regarding the agent's response to the user or feedback from the agent regarding the relevance or appropriateness of the AI recommended reply messages). In some approaches, the historical data includes the AI recommended reply messages that were recommended in response to each user message (e.g., by associating the specific AI recommended reply messages with the specific user message) and may include information regarding which AI recommended reply messages 164 were ultimately selected by the agent and transmitted in the chat (e.g., by associating the selected AI recommended reply message with the specific user message and with the plurality of AI recommended reply messages that were recommended in response to the specific user message). In some embodiments, the data includes information regarding one or more lengths of time or time periods associated with a safety alert 106. For instance, a length of time may be from receipt of the safety alert to one or more predefined terminating actions of the safety alert. In some examples, the predefined terminating actions may be an indication of resolution of the alert or cancellation of the alert from the user, a lack of response from the user after a predefined amount of time, an indication of resolution of the alert from the agent or from the AMS, or an indication of transfer of responsibility for the incident to a different party, such as to an emergency service provider, emergency dispatch center, public-safety answer point, or other first responders. The data may also include a total length of time of a chat session (e.g., from the first message to the last message) and/or one or more lengths of time between a user message and a subsequent agent response during the chat session. In one approach, the lengths of time between each user message and each subsequent agent response are recorded and used to train the machine learning model 132 to recommend response messages that increase the efficiency of the chat session by shortening the time it takes for the agent to respond to user messages. In embodiments, other lengths of time, such as any of the above-mentioned lengths of time, may be recorded and used to train the machine learning model 132 to recommend response messages that increase the efficiency of the chat session by shortening the time it takes for the agent to respond to user messages.

In some approaches, initiating the chat session between the user and the agent includes providing or receiving a unique alert identifier 111 for the safety alert 106. In some embodiments, the unique alert identifier 111 associates, at least, the entire message history of the chat session, the one or more recommended reply messages 164 (e.g., that are provided for each user message), and the data associated with the alert (e.g., including information regarding the agent-selected AI recommended reply messages) together in a database. Associating this information via the unique alert identifier 111 permits this associated information to be used in a data set to train the machine learning model 132 to provide more apt responses.

As specified at block 320, the machine learning model 132 may determine one or more recommended reply messages 164 for responding to the user message by selecting at least one most relevant pre-determined or script reply message from a stored library of pre-determined or script reply messages relating to at least one type of safety issue. This determination may be based at least on the last user message. In an illustrative embodiment, this determination is based at least on an entire message history of the chat session. Advantageously, determining the recommended reply messages based on the entire message history provides important contextual input to the machine learning model 132 to determine intentions, subtext, and, ultimately, the meaning of the conversation to output more precise responses. Basing the recommended reply messages on the entire message history also helps avoid any repetitious or inefficient responses. Indeed, based on the techniques described herein, the resolution time of alerts has been shown to decrease. In other words, these teachings can help provide faster resolution of emergency alerts.

In some approaches, the determination of the recommended reply messages is based at least on an entire message history of the chat session and the user data. In some approaches, the determination may further be based on any of the other above-mentioned information or data that may be associated with the safety alert 106 (e.g., sensor data). For example, in one approach, the machine learning model 132 determines the one or more recommended reply messages 164 based on contextual information extracted from one or more of sensor data, camera data, emergency call data, law enforcement data, weather data, and geolocation data. In some embodiments, the machine learning model 132 determines the recommended reply messages 164 based at least in part on location information generated by the user device and received by the AMS 115.

The stored library of pre-determined reply messages may be stored, for example, in databases 147 of the AMS 115 associated with the alert response application 125. The stored library of pre-determined reply messages may include, for example, the messages 163 in the above-mentioned script response pool 162. In some approaches, the stored library includes pre-determined scripts associated with different services/third-party providers, with different types of safety alert(s), issue(s), and/or with different types of response(s). The stored library, may, in some embodiments, include a categorization scheme for categorizing messages (e.g., type of service/third-party provider, type of safety alert or issue, type of response, etc.). In some embodiments, a category is first determined, after which recommended reply messages are selected from the messages within that category. For instance, the AI engine 130 may determine (e.g., by parsing the messages or message history) or receive an indication (e.g., input from the user or the agent) of a certain category of safety alert, and then determine the most relevant reply messages categorized under that category of safety alert.

In certain approaches, the machine learning model 132 may use the inputs to analyze relevance and rank the pre-determined reply messages in the stored library to determine the most relevant messages to recommend. In some approaches, the messages are ranked according to specific criteria, and the ranking is provided to the agent when the messages are displayed. In some embodiments, the recommended reply messages are ranked based on the results of a classifying algorithm. This algorithm utilizes labeled historical data to determine the most typical reply messages given the situation at hand. By analyzing past interactions and outcomes, the system can prioritize the most relevant and effective recommendations for the current context. In embodiments, the ranking criteria may be derived from the performance of historical recommended reply messages. Factors such as accuracy, relevance, and the success rate of historical recommendations in similar situations are considered. This ensures that the highest-ranked reply messages are those that are most likely to be useful and appropriate for the current scenario.

Further, as explained in more detail below, the system is designed to continuously learn and improve its recommendations. Since the monitoring agents have the option to input their own responses if they find that none of the proposed recommendations are a good fit, this feedback may then be incorporated into the model 132, allowing it to learn from new data and refine its algorithms and rankings. Over time, this results in more accurate and contextually appropriate recommendations.

In some embodiments, the machine learning model 132 determines whether to select a pre-determined reply message pertaining to the user needing on-site assistance. For instance, the machine learning model 132 may parse the user message to determine presence of a literal or intended request for on-site assistance or to determine indication of a situation which typically requires on-site assistance. The machine learning model 132 may then select an appropriate pre-determined reply message relating to the user needing on-site assistance, for example, confirming or asking whether the user needs on-site assistance, confirming that on-site assistance is on the way, and/or providing instructions to the user regarding the on-site assistance.

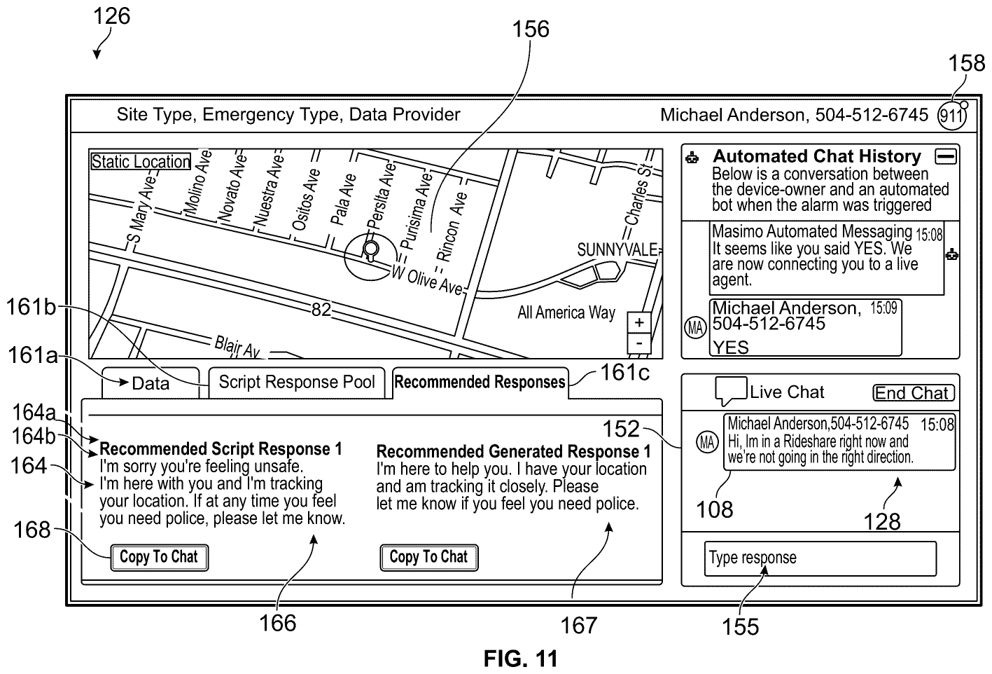

At block 325, the method 300 includes displaying the one or more recommended reply messages on the graphical user interface. For instance, as explained above, the recommended reply messages 164 may be displayed in a recommended responses tab 161c or portion of the safety response portal 126 (FIG. 11) so that the agent can easily review the recommended reply messages for entering into the chat. At block 330, the method 300 includes receiving a selection indicating an agent-selected message from the safety agent, the agent-selected message including one of the one or more recommended reply messages 164. The method 300 may also include transmitting the agent-selected message via the chat to the user device. As noted above, the agent-selected message may be first copied into the input portion 155 of the chat (e.g., by pressing a “copy to chat” button 168 associated with the recommended reply message). In embodiments, the agent may be permitted to edit the message in the input portion 155 before sending the response. In some embodiments, the AMS 115 tracks which recommended reply messages 164 are selected and ultimately sent to the user device 104, whether the recommended reply messages are edited or not. In some approaches, the AMS 115 may keep track of any edits the agent made to the recommended reply message 164 before sending. Data regarding which of the recommended reply messages are selected and transmitted and how the recommended reply messages are edited may be associated with the safety alert 106 used in a training data set to train the machine learning model 132.

In addition, the agent has the option to not select any of the recommended reply messages 164. Instead, the agent may freely enter a reply message, or may select (and, optionally, edit), a pre-determined script message 163 from the script response pool 162 (FIG. 11). In the first scenario, the AMS 115 may associate the last user message, the agent's freely entered reply message, and the recommended reply messages provided for responding to the last user message. In the second scenario, the AMS may associate the last user message, the agent-selected message from the script response pool 162, and the recommended reply messages provided for responding to the last user message. This data may be used to train the machine learning model 132 by tracking the differences between the freely entered reply message and the recommended reply messages or tracking the differences between the agent-selected message from the script response pool 162 and the recommended reply message. That is, the machine learning model 132 uses the agent's reply messages to learn certain deficiencies of the previously recommended reply messages in order to improve future output of recommended reply messages. In some embodiments, the freely entered reply message or edited reply message is input into the model 132 as historical data for determining future recommended reply messages in like scenarios.

After block 330, the steps in blocks 315, 320, 325, and 330 may repeat for each additional user message that is received. That is, in certain approaches, for each user message that is received in the chat, the artificial intelligence engine 130 may determine and output a set of oen or more recommended reply messages 164 to display to the agent in the manner described above. Thus, the AMS 115 provides dynamic recommendations based on analysis of the last user message in light of the entire message history.

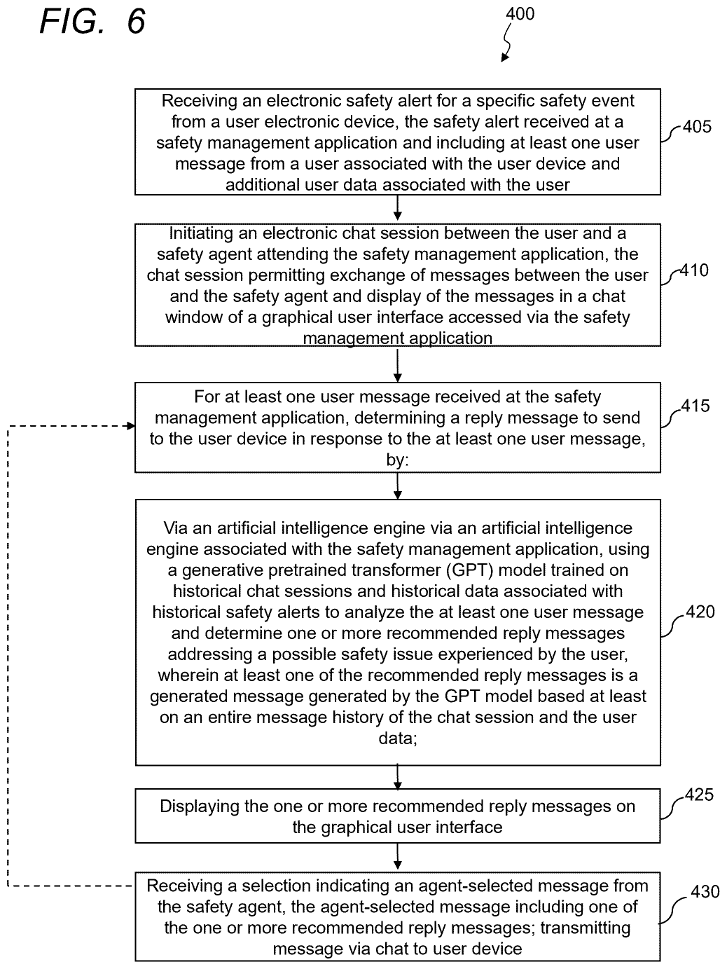

FIG. 6 shows another exemplary method 400 for facilitating electronic safety alert communications by a safety alert management system (AMS) (e.g., such as alert management system 115). With reference to FIGS. 1 and 6, the method 400 includes, at block 405, receiving an electronic safety alert 106 for a specific safety event from a user electronic device 104 at the AMS 115. The user electronic device 104 may be any of the user devices described above, for instance, a mobile phone. As described above, the safety alert 106 may be transmitted using a safety alert program 139 on or accessed via the user electronic device, and may be transmitted directly to the AMS 115 or indirectly to the AMS 115 via servers of a third party service provider 112. In some embodiments, the safety alert program 139 may include a communication or chat interface 105 to enable a two-way text-based chat session in substantially real time.

In embodiments, the safety alert 106 transmitted to the AMS 115 includes at least one user message 108 (e.g., a text-based message) from a user associated with the user electronic device. The user messages 108 may be input by the user via the chat interface 105. The safety alert 106 may also include a notification that assistance is needed. In some embodiments, the notification may include at least one of a type of incident, location of the incident, and urgency of the incident. This information may be input by the user using the safety alert program 139 freely or in response to form prompts or automated bot prompts, and may be input prior to initiating the safety alert or after initiating the safety alert. The safety alert 106 may also include additional information or data, such as user data associated with the user (e.g., name, phone number, medical history), geolocation data (e.g., current GPS location of the device), and any associated sensor data. Upon receipt of the safety alert 106, the AMS 115 may also query internal data sources and/or external data sources 134 and/or sensors 136 that, for instance, may be associated with a location of the incident, with the user, or with the user electronic device to attain additional contextual information.

At block 410, the method 400 includes initiating an electronic chat session between the user and a safety agent attending a safety management application or safety alert response application 125 of the alert management system 115. As described above, the electronic chat session may be displayed in a safety chat interface or chat portion 128 of the graphical user interface of the alert response application 125 accessed at the monitoring device 138. These steps may be the same as described above with respect to method 300.

At block 415, the method 400 includes, for at least one user message received at the alert response application 125, determining a reply message to send to the user device in response to the at least one user message. In certain situations, an agent may simply independently respond to the user message by freely inputting a reply message into the chat interface 128. In addition, an agent may select an appropriate script response message 163 from a script response pool 162 displayed in a portion of the graphical user interface. However, advantageously, the alert response application 125 may additionally employ artificial intelligence to provide a select number of recommended reply messages 164 to assist the agent in determining a reply message. Specifically, in embodiments, the alert response application 125 interacts with an artificial intelligence response engine 130 that includes one or more machine learning models 132, as described above. Thus, for at least one user message received at the alert response application 125, determining a reply message to send to the user device in response to the user message may include the steps at blocks 420, 425, and 430.

Specifically, at block 420, the method 400 includes, via the artificial intelligence response engine 130, using a machine learning model 132, for example, a generative pretrained transformer (GPT) model to parse and analyze the at least one user message 108 and determine one or more recommended reply messages addressing a possible safety issue experienced by or described by the user. In embodiments, the machine learning model 132 is trained, at least, on historical or prior safety alerts 106, for example on historical safety alert chat sessions and historical data associated with the historical safety alerts 106. The historical data may include any of the historical data described above with respect to method 300. The artificial intelligence response engine 130 and machine learning model 132 may be the same as that discussed above with respect to method 300, though, in this case, used to generate text responses (described further below).

Further, as described above for method 300, the method 400 may include providing or receiving a unique alert identifier 111 for the safety alert 106. In some embodiments, the unique alert identifier 111 associates, at least, the entire message history of the chat session, the one or more recommended reply messages (e.g., that are provided for each user message), and the data associated with the alert (e.g., including information regarding the agent-selected AI recommended reply messages) together in a database. Associating this information via the unique alert identifier 111 permits this associated information to be used in a data set to train the machine learning model 132 to provide more apt responses.

As specified at block 420, the machine learning model 132 may determine the one or more recommended reply messages 164 by generating the messages. That is, at least one of the recommended reply messages 164 (and, in some approaches, all of the recommended reply messages) is a generated message 167 generated by a generative machine learning model 132. The generated messages 167 may be based at least on the last user message (i.e., the last user message is an input). In an illustrative embodiment, the generation is based at least on an entire message history of the chat session to provide increased contextual input for precise generated responses. In some embodiments, the generation of the recommended reply messages 164 is based at least on an entire message history of the chat session and the user data. In some approaches, the generation may further be based on any of the other above-mentioned information or data that may be associated with the safety alert 106. For example, in one approach, the machine learning model 132 generates the one or more recommended generated reply messages 167 based on contextual information extracted from one or more of sensor data, camera data, emergency call data, law enforcement data, weather data, and geolocation data. In some embodiments, the machine learning model 132 generates the recommended generated reply messages 167 based at least in part on location information generated by the user device 104 and received by the AMS 115.

In some embodiments, the machine learning model 132 generates a recommended generated reply message 167 pertaining to the user needing on-site assistance. For instance, the machine learning model 132 may parse the user message to determine presence of a literal or intended request for on-site assistance or to determine indication of a situation which typically requires on-site assistance. The machine learning model 132 may then generate an appropriate reply message relating to the user needing on-site assistance, for example, confirming or asking whether the user needs on-site assistance, confirming that on-site assistance is on the way, and/or providing instructions to the user regarding the on-site assistance.

At block 425, the method includes displaying the one or more recommended reply messages 164 on the graphical user interface. For instance, as explained above, the recommended generated reply messages 167 may be displayed in a recommended responses tab 161c or portion of the safety response portal 126 (FIG. 11) so that the agent can easily review the recommended reply messages for entering into the chat. At block 430, the method 400 includes receiving a selection indicating an agent-selected message from the safety agent, the agent-selected message including one of the one or more recommended reply messages 164. The method 400 may also include transmitting the agent-selected message via the chat to the user device, as discussed above for method 300. In addition, like in method 300, the AMS 115 may track which recommended reply messages 164 are selected and ultimately sent to the user device 104, regardless of whether the recommended reply messages 164 are edited by the agent before sending. In some approaches, the AMS 115 may keep track of any edits the agent made to the selected recommended reply message 164 before sending. Data regarding which of the recommended reply messages 164 are selected and transmitted and how the recommended reply messages 164 are edited may be associated with the safety alert 106 used in a training data set to train the machine learning model 132.

In addition, like with method 300, in method 400 the agent has the option to not select any of the recommended reply messages 164. Instead, the agent may freely enter a reply message, or may select (and, optionally, edit), a pre-determined script message 163 from the script response pool 162 (FIG. 11). In the first scenario, the AMS 115 may associate the last user message, the agent's freely entered reply message, and the recommended reply messages provided for responding to the last user message. In the second scenario, the AMS 115 may associate the last user message, the agent-selected message from the script response pool 162, and the recommended reply messages provided for responding to the last user message. This data may be used to train the machine learning model 132 by tracking the differences between the freely entered reply message and the recommended reply messages or tracking the differences between the agent-selected message from the script response pool 162 and the recommended reply message. Thus, the machine learning model 132 uses the agent's reply messages to learn certain deficiencies of the previously recommended reply messages in order to improve future output of recommended reply messages. In some embodiments, the freely entered reply message or edited reply message is input into the model 132 as historical data for determining future recommended reply messages in like scenarios.

After block 430, the steps in blocks 415, 420, 425, and 430 may repeat for each additional user message that is received. That is, in certain approaches, for each user message that is received in the chat, the artificial intelligence engine may determine and output a set of recommended reply messages to display to the agent in the manner described above. Thus, the AMS 115 provides dynamic recommendations based on analysis of the last user message in light of the entire message history.

In some approaches, the machine learning model 132 may be configured to output both recommended generated reply messages 167 and recommended pre-determined (or script) reply messages 166. This approach may be a combination of processes 300 and 400 (specifically, a combination of blocks 320 and 420). For instance, the machine learning model 132 (e.g., the GPT model) would be configured to generate at least one recommended generated reply message 167 and select at least one recommended (e.g., most relevant) pre-determined reply message 166 from the stored library of pre-determined reply messages. In this approach, the machine learning model 132 may determine whether to generate at least one recommended generated reply message 167 and determine whether to select at least one recommended pre-determined reply message 166 from the stored library of pre-determined reply messages. In some approaches, the machine learning model 132 may compare the recommended generated reply messages 167 to the selected recommended pre-determined reply messages 166 to determine which recommended reply messages to display to the agent. In some embodiments, the recommended generated reply messages 167 are generated first and are used as a guide in order to select the recommended pre-determined reply messages 166 (e.g., select the pre-determined reply messages that are most similar to the recommended generated reply messages 167).

In some approaches, when the machine learning model 132 is configured to output both recommended generated reply messages 167 and recommended pre-determined reply messages 166, the method 400 may include displaying the recommended reply messages 164 in the safety response portal 126 by indicating via at least one of color, text, or placement whether a displayed recommended reply message 164 is one of the recommended pre-determined reply messages 166 or one of the recommended generated reply messages 167. For instance, as described above, FIG. 11 shows that the different types of recommended reply messages 164 are labeled as a recommend script response or a recommend generated response. Though the figure only shows one of each type, it will be appreciated that there may be more than one of each type. In embodiments, for example, there may be at least one recommended reply message 164, with 0 to 5 recommended pre-determined reply messages 166 and 0 to 5 recommended generated reply messages 167.

In some approaches, the machine learning model 132 determines whether to generate a reply message 167 based on certain criteria being met. For instance, in some approaches, the machine learning model 132 only outputs a recommended generated reply message 167 if the safety alert 106 is determined to fall under a certain category. For instance, in some embodiments the generative AI function may only be employed for certain categories of safety alert 106 or when the safety alert 106 originates from specific services or third-party applications. This can help ensure that the generative AI function is only employed in tested scenarios for which the machine learning model 132 has suitable training or demonstrated success, to ensure the quality and consistency of the recommended generated reply messages 167.

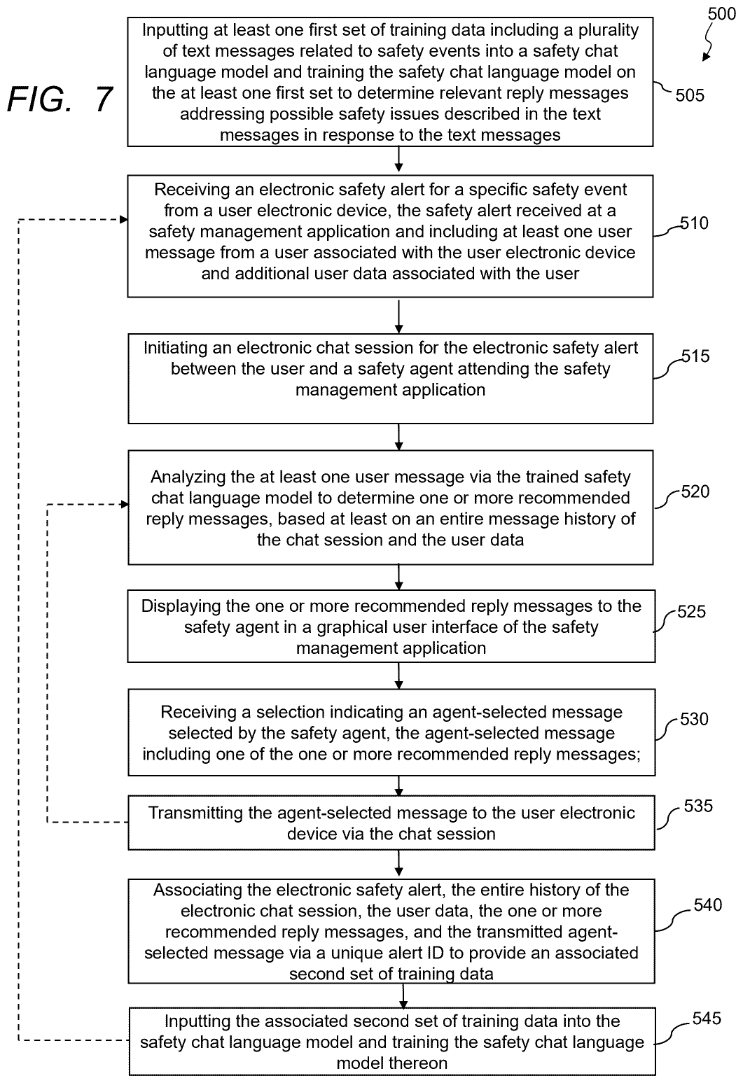

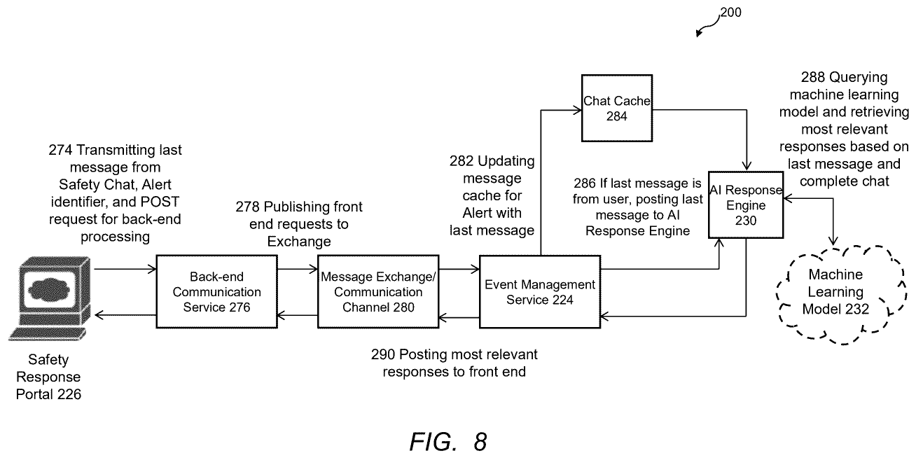

FIG. 7 shows an exemplary method 500 for training a safety chat language model in a safety alert management system (AMS) (e.g., such as the machine learning model 132 in alert management system 115). With reference to FIGS. 1 and 8, the method includes, at block 505, inputting at least one first set of training data including a plurality of text messages related to safety events into a safety chat language model and training the safety chat language model on the at least one first set to determine relevant reply messages addressing possible safety issues described in the text messages in response to the text messages. In some approaches, the at least one first set of training data may include other types of messages having media such as images, video, or audio. In some embodiments, the at least one first set of training data includes other types of data associated with the text messages, such as certain types of contextual data (e.g., user data, sensor data, camera data, emergency call data, medical/health data, law enforcement data, weather data, demographic data, multimedia or news feed data, and/or geolocation data). The data sets for training may include contrived data or real historical data. In some approaches, the at least one first set of training data includes historical safety chat sessions and historical data associated with historical safety alerts. The historical data associated with historical safety alerts may include any of the contextual data indicated above as well as resolution data (e.g., how the safety alert was resolved) and/or performance data (e.g., specific metrics for evaluating the response to the safety alert such as time/efficiency, accuracy, user satisfaction, agent satisfaction, etc.). As mentioned above, the historical data associated with historical safety alerts may also include specific associations between each user message, the AI-recommended reply messages output for each user message, and the agent message that is ultimately submitted in response to the user message, in order to improve the quality of the recommended reply messages.

The method 500 may include, at block 510, receiving an electronic safety alert for a specific safety event from a user electronic device 104, the safety alert 106 received at a safety management application 125 of an alert management system (AMS) 115, such as the safety management application 125 and AMS described in the foregoing embodiments. The user electronic device 104 may be any of the user devices described above, for instance, a mobile phone. As described above, the safety alert 106 may be transmitted using a safety alert program 139 on or accessed via the user electronic device 104, and may be transmitted directly to the AMS 115 or indirectly to the AMS 115 via servers of a third party service provider 112. In some embodiments, the safety alert program 139 may include a communication or chat interface 105 to enable a two-way text-based chat session in substantially real time.

In embodiments, the safety alert 106 transmitted to the AMS 115 includes at least one user message 108 (e.g., a text-based message) from a user associated with the user electronic device 104. The user messages 108 may be input by the user via the chat interface 105. The safety alert 106 may also include a notification that assistance is needed. In some embodiments, the notification may specify at least one of a type of incident, location of the incident, and urgency of the incident. This information may be input by the user using the safety alert program 139 freely or in response to form prompts or automated bot prompts, and may be input prior to initiating the safety alert 106 or after initiating the safety alert 106. The safety alert 106 may also include additional information or data, such as user data associated with the user (e.g., name, phone number, medical history), geolocation data (e.g., current GPS location of the device), and any associated sensor data. Upon receipt of the safety alert 106, the AMS 115 may also query internal data sources and/or external data sources 134 and/or sensors 136 that, for instance, may be associated with a location of the incident, with the user, or with the user electronic device to attain additional contextual information.

At block 515, the method includes initiating an electronic chat session between the user and a safety agent attending the safety alert response application 125 of the AMS 115. For instance, as noted above, the safety alert response application 125 may be accessed via a monitoring device 138 of the agent, at or associated with, for example, a central monitoring station or service 137. The task of the safety agent may be to monitor, triage, respond to, and/or resolve safety alerts 106 when they are received by the system 115. The safety agent may further have the task of escalating safety alerts 106 if necessary by requesting assistance from first responders or other emergency personnel. As described above for earlier embodiments, the electronic chat session may be displayed in a safety chat interface or chat portion 128 of the graphical user interface of the alert response application 125 accessed at the monitoring device 138. These steps may be the same as described above with respect to processes 300 and 400.

At block 520, the method includes analyzing the at least one user message 108 via the trained safety chat language model to determine one or more recommended reply messages 164. In embodiments, this determination occurs for each user message 108 that is received in the chat (e.g., the trained safety chat language model outputs a new set of recommended reply messages 164 for the agent to review in response to each user message 108). The recommended reply messages may be determined by the trained safety chat language model in any of the ways described above with respect to processes 300 and 400. For instance, the trained safety chat language model may be configured to generate one or more recommended generated reply messages 167, select one or more recommended pre-determined reply messages 166 (from a stored library of pre-determined reply messages), or both. In embodiments, and as discussed above, determining the recommended reply messages may be based on an entire message history of the chat. Any of the other inputs described above (e.g., user data, location data, or other contextual data) may also be used as inputs to the model determine the recommended reply messages.

At block 525, the method includes displaying the one or more recommended reply messages to the agent in the graphical user interface. For instance, in the manner described above, the recommended reply messages 164 may be displayed in a recommended responses tab 161c or portion of the safety response portal 126 (FIG. 11) so that the agent can easily review the recommended reply messages for entering into the chat. At block 530, the method includes receiving a selection indicating an agent-selected message from the safety agent, the agent-selected message including one of the one or more recommended reply messages. The method may also include, at block 535, transmitting the agent-selected message via the chat to the user device, as discussed above for processes 300 and 400. In addition, like in processes 300 and 400, the AMS may track which recommended reply messages 164 are selected and ultimately sent to the user device, regardless of whether the recommended reply messages 164 are edited by the agent before sending. In some approaches, the AMS 115 may keep track of any edits the agent made to the selected recommended reply message 164 before sending. Data regarding which of the recommended reply messages 164 are ultimately selected and transmitted and how the recommended reply messages 164 are edited may be associated with the safety alert 106 and used in a training data set to train the model.

In addition, like with methods 300 and 400, in method 500 the agent has the option to not select any of the recommended reply messages 164. Instead, the agent may freely enter a reply message, or may select (and, optionally, edit), a pre-determined script message 163 from the script response pool 162 (FIG. 11). In the first scenario, the AMS 115 may associate the last user message, the agent's freely entered reply message, and the recommended reply messages provided for responding to the last user message. In the second scenario, the AMS 115 may associate the last user message, the agent-selected message from the script response pool 162, and the recommended reply messages 164 provided for responding to the last user message 108. This data may be used to train the model 132 by tracking the differences between the freely entered reply message and the recommended reply messages 164 or tracking the differences between the agent-selected message from the script response pool 162 and the recommended reply messages 164. Thus, the model 132 is trained on the agent's reply messages to learn certain deficiencies of the previously recommended reply messages 164 in order to improve future output of recommended reply messages 164. In some embodiments, the freely entered reply message or edited reply message is input into the model 132 as historical data for determining future recommended reply messages in like scenarios.

After block 535, the steps in blocks 520, 525, 530, and 535 may repeat for each additional user message that is received. That is, in certain approaches, for each user message that is received in the chat, the trained safety chat language model may determine and output a set of recommended reply messages 164 to display to the agent in the manner described above.

The method 500 may also include, at block 540, a step in which the AMS 115 associates the electronic safety alert 106, the entire message history of the electronic chat session, the user data, the one or more recommended reply messages, and the transmitted agent-selected message via a unique alert identifier (e.g., the unique alert identifier 111 described above) to provide an associated second set of training data. At block 545, the method may include inputting the associated second set of training data into the safety chat language model and training the safety chat language model on the second set of training data. The steps at blocks 510 to 545 may then be repeated for subsequent safety alerts 106, resulting in the creation and inputting of subsequent sets of training data to train the safety chat language model. Thus, the safety chat language model may advantageously undergo a continuous training process as new safety alerts are received, refining the safety chat language model over time as a result of constant new data.

In some approaches, at block 540, the AMS 115 may also associate additional information or data with the safety alert 106 via the unique alert identifier 111 to provide the associated second (or subsequent) set of training data. For instance, the data may include any of the other types of data associated with the text messages, such as certain types of contextual data (e.g., sensor data, camera data, emergency call data, medical/health data, law enforcement data, weather data, demographic data, multimedia or news feed data, and/or geolocation data). In addition, the data may include specific associations between each user message, the AI-recommended reply messages output for each user message, and the agent message that is ultimately submitted in response to the user message, in order to improve the quality of future recommended reply messages. The associated data may also include resolution data (e.g., how the safety alert 106 was resolved) and/or performance data (e.g., specific metrics for evaluating the response to the safety alert such as time/efficiency, accuracy, user satisfaction, agent satisfaction, etc.).

In some embodiments, the method 500 may include measuring one or more time periods associated with the safety alert 106, associating the one or more time periods with the second set of training data via the unique alert identifier, and training the safety chat language model on the second set of training data to determine subsequent recommended reply messages 164 based on time efficiency. The duration of the chat session or safety alert 106 is a crucial factor, as it allows the model to understand the dynamics of the conversation and improve the recommendations accordingly. Specifically, by analyzing the time taken for each chat session or alert, and, in some approaches, breaking down the chat session or alert into smaller time periods to assess the time more granularly, the model can identify patterns and trends that help in optimizing or reducing the response time or resolution time and provide more precise recommendations aimed at improving efficiency. In some approaches, the one or more time periods may be selected from a total length of time of the chat session or safety alert 106, a length of time between receipt of any specific user message and transmission of an agent-selected message in reply to the specific user message, or both.

In some embodiments, for instance, a total length of time may be from receipt of the safety alert 106 (e.g., a first user message or notification received in the live chat portion of the safety chat 128) to one or more predefined terminating actions of the safety alert 106. In some examples, the predefined terminating actions may be an indication of resolution of the alert or cancellation of the alert from the user, a lack of response from the user after a predefined amount of time, an indication of resolution of the alert from the agent, from other sources, or as determined by the AMS 115, or an indication of transfer of responsibility for the incident from the monitoring station 138 to a different party, such as to an emergency service provider, emergency dispatch center, public-safety answer point, or other first responders. In some embodiments, a total length of time may be a total length of time of a chat session (e.g., from the first message to the last message). One or more lengths of time between a user message and a subsequent agent response during the chat session may also be measured and included in the training set. In one approach, the lengths of time between each user message and each subsequent agent response are recorded and used to train the machine learning model to recommend response messages that increase the efficiency of the chat session by shortening the time it takes for the agent to respond to user messages. In these approaches, the durations of the chat session or alert are used as a metric to assess the efficiency of the response to the user.

In addition, other types of metrics and data may be used to train the machine learning model (and employed in any of methods 300, 400, and 400, as well as process 200 described below). For instance, the accuracy of the recommended reply messages provided by the model is an important metric, since ensuring that the recommendations are correct and helpful is vital for the system's effectiveness. For example, human feedback may be received for the recommended reply messages that may be incorporated into the model, such as from the monitoring agent (during the session or after the session) or from other human reviewers. For example, in one embodiment one or more feedback buttons may be displayed next to each recommended reply message (e.g., a plus button and a negative button, helpful/not helpful buttons) that the agent may select to provide quick feedback to the system. In some embodiments, the user may have the option to rate the accuracy or helpfulness of each message from the agent (or the entire chat session and/or safety alert), which feedback may be incorporated into the model.

In some approaches, agent satisfaction with using the AI recommended reply messages may be a further metric for training the model. For instance, in some embodiments, the GUI may prompt the agent to rate the agent's satisfaction with a session after the session is complete, or rate certain attributes of the session. For instance, the agents may be prompted to rate how helpful and/or accurate the recommended reply messages were. This feedback may be incorporated into the model.

In some embodiments, an agent may be prompted by the GUI to provide certain feedback or information about the safety alert, either during the safety alert or after completion of the chat session. For instance, in one approach, the agent may be prompted to select a specific category for the safety alert (e.g., “request for dispatch”, “accidental call,” “dispatch due to no response”, “user is anxious”, etc.). This information may be used to train the model.

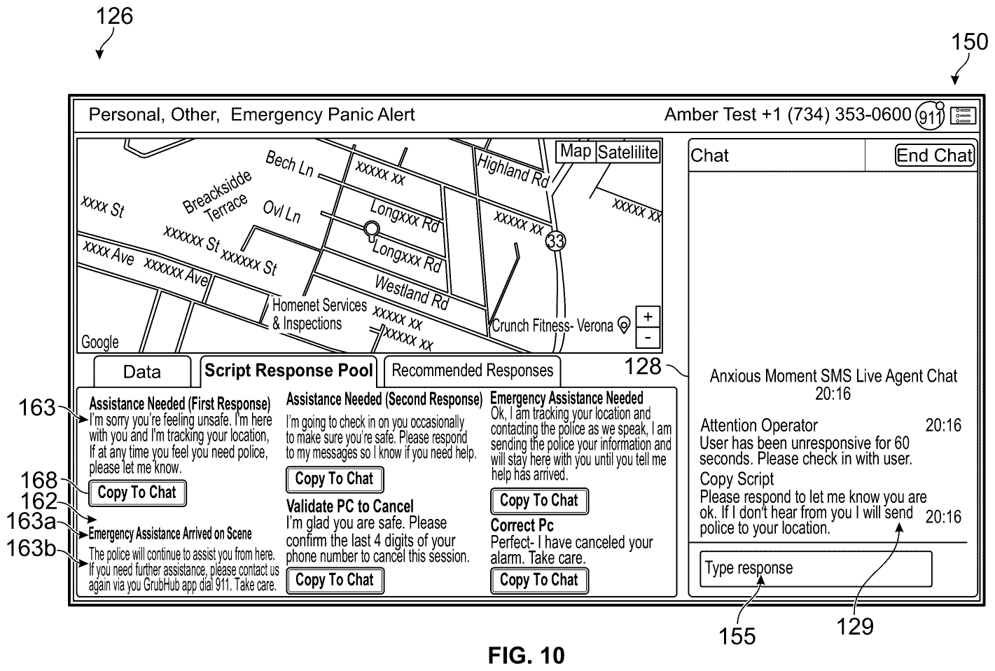

In some approaches, other contextual factors, such as the complexity of the user's incident or query and the specific needs of the incident may also be used to train the model. FIG. 8 shows an exemplary process 200 or flow of an alert management system (AMS) (e.g., the alert management system 115) that may occur at the back-end of the alert response application 125 or safety response portal 226 to determine recommended reply messages 164 for the safety chat 128 (FIG. 10). Features of the AMS in process 200 that are like those of system 100 are indicated with a reference number having the same last two digits as the feature in system 100, except the reference number begins with a “2”.

The exemplary process 200 begins when, at 274, a last (i.e., most recent) chat message 108 transmitted in the safety chat 128 via the alert response application 125 or safety response portal 226 is transmitted for back-end processing. The last chat message may be transmitted along with the alert identifier 111 for the safety alert 106. Transmitting the last chat message may, in some embodiments, occur via a POST request for back-end processing to a back-end communication service 276 for data exchange. The communication service 276, in some embodiments, uses a websocket based communication channel to exchange data.

In some embodiments, the transmitted chat message and request, at 278, may be published to a message exchange or further communication channel 280. An event management service 224 may also be employed to pick up the transmitted chat message and request. At 282, the chat message may be stored in a database. For instance, in some approaches, the database may include a chat cache 284 containing all the messages of the chat (i.e., the entire chat history) for the specific safety alert 106, and the transmitted chat message is added to the chat cache.

If the transmitted chat message is specifically a user message 108, the artificial intelligence response engine 230 is queried. Specifically, at 286, the user message 108 may be posted (e.g., through HTTP) to the artificial intelligence response engine 230, which queries at least one machine learning model 232 (e.g., a trained GPT model) to determine one or more recommended reply messages. In some approaches, the entire chat history of the safety alert 106 is input into the machine learning model 232 along with the last user message 108 and the machine learning model 232 determines the one or more recommended reply messages based on analyzing the last user message 108 and the entire chat history. The machine learning model 232 may determine the one or more recommended reply messages in any of the manners discussed above with respect to methods 300, 400, and 500.

After determining the one or more recommended reply messages, the AI response engine 230 may transmit the one or more recommend reply messages back to the front end, for example, via the event management service 224, the message exchange 280, and the communication service 276.

In certain approaches, after determining the one or more recommended reply messages, the process 200 may include updating a database system 118 of the AMS 115 with the one or more recommended reply messages. The one or more recommended reply messages may be associated with the collection of other data from the specific safety alert 106 via the alert identifier 111. As explained above, the one or more recommended reply messages may be stored in association with the user message and the final reply message sent by the agent. The associated data may then be used as historic alert data 120 to train the machine learning model 232 to output more accurate recommended reply messages. Thus, the machine learning model 232 may continuously “learn” and improve based on the final decisions made by the human safety agent over time.

### Machine Learning Algorithms

In some embodiments, the systems and methods described herein use one or more algorithms analyzing safety alert data including safety chat message history, as described above. In some embodiments, machine learning algorithms, such as via a pre-trained transformer GPT model, are used for providing recommended reply messages in the safety chat 128 and for training models associated therewith. In some embodiments, machine learning algorithms are used for training models for generating questions or responses to questions as part of the chat session of the safety chat 128. In some embodiments, a machine learning model is trained to evaluate messages from a user and generate an output indicative of a response or communication or type of response or communication to the user. As an illustrative example, a user message requesting help and stating that there was a car accident may be processed by the model to generate an output corresponding to a response that the police are on the way. In some instances, machine learning methods are applied to the generation of such models.

In some embodiments, a machine learning algorithm uses a supervised learning approach. In supervised learning, the algorithm generates a function from labeled training data. Each training example is a pair consisting of an input object and a desired output value. In some embodiments, an optimal scenario allows for the algorithm to correctly determine the class labels for unseen instances. In some embodiments, a supervised learning algorithm requires a user to determine one or more control parameters. These parameters are optionally adjusted by optimizing performance on a subset, called a validation set, of the training set. After parameter adjustment and learning, the performance of the resulting function is optionally measured on a test set that is separate from the training set. Regression methods are commonly used in supervised learning. Accordingly, supervised learning allows for a model or classifier to be generated or trained with training data in which the expected output is known such as when the safety category for past safety events or alerts have been confirmed.

In some embodiments, a machine learning algorithm uses an unsupervised learning approach. In unsupervised learning, the algorithm generates a function to describe hidden structures from unlabeled data (e.g., a classification or categorization is not included in the observations). Since the examples given to the learner are unlabeled, there is no evaluation of the accuracy of the structure that is output by the relevant algorithm. Approaches to unsupervised learning include clustering, anomaly detection, and neural networks.

In some embodiments, a machine learning algorithm learns in batches based on the training dataset and other inputs for that batch. In other embodiments, the machine learning algorithm performs on-line learning where the weights and error calculations are constantly updated.

In some embodiments, a machine learning algorithm is applied to new or updated safety alert data to be re-trained to generate a new or updated model. In some embodiments, a machine learning algorithm or model is re-trained periodically. In some embodiments, a machine learning algorithm or model is re-trained non-periodically. In some embodiments, a machine learning algorithm or model is re-trained at least once a day, a week, a month, or a year or more. In some embodiments, a machine learning algorithm or model is re-trained at least once every 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days or more. In some embodiments, a machine learning algorithm or model is re-trained with every safety alert that occurs, or is re-trained with some of the safety alerts that occur, such that the training is more continuous in manner.

In some instances, machine learning methods are applied to select, from a plurality of models generated, one or more particular models that are more applicable to certain attributes. In some embodiments, different models are generated depending on the distinct sets of attributes obtained for various communications.

In some embodiments, the classifier or trained algorithm of the present disclosure comprises one feature space. In some cases, the classifier comprises two or more feature spaces. In some embodiments, the two or more feature spaces are distinct from one another. In various embodiments, each feature space comprise types of attributes associated with a safety alert or communication such as the location, user identity, user demographic information (e.g., gender, age, ethnicity, etc.), and other types of relevant safety alert information. In some embodiments, the accuracy of the classification or prediction is improved by combining two or more feature spaces in a classifier instead of using a single feature space. The attributes generally make up the input features of the feature space and are labeled to indicate the classification of each communication for the given set of input features corresponding to that communication.

In some embodiments, an algorithm utilizes a predictive model such as a neural network, a decision tree, a support vector machine, or other applicable model. Using the training data, an algorithm is able to form a classifier for generating a classification or prediction according to relevant features. The features selected for classification can be classified using a variety of viable methods. In some embodiments, the trained algorithm comprises a machine learning algorithm. In some embodiments, the machine learning algorithm is selected from at least one of a supervised, semi-supervised and unsupervised learning, such as, for example, a support vector machine (SVM), a Naïve Bayes classification, a random forest, an artificial neural network, a decision tree, a K-means, learning vector quantization (LVQ), regression algorithm (e.g., linear, logistic, multivariate), association rule learning, deep learning, dimensionality reduction and ensemble selection algorithms. In some embodiments, the machine learning algorithm is a support vector machine (SVM), a Naïve Bayes classification, a random forest, or an artificial neural network. Machine learning techniques include bagging procedures, boosting procedures, random forest algorithms, and combinations thereof.

In some embodiments, a machine learning algorithm such as a classifier is tested using data that was not used for training to evaluate its predictive ability. In some embodiments, the predictive ability of the classifier is evaluated using one or more metrics. These metrics include accuracy, specificity, sensitivity, positive predictive value, negative predictive value, which are determined for a classifier by testing it against a set of independent cases. In some instances, an algorithm has an accuracy of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a specificity of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a sensitivity of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a positive predictive value of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances an algorithm has a negative predictive value of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein.

In some embodiments, the safety alert data and/or chat messages undergo natural language processing using one or more machine learning algorithms. In some embodiments, the one or more machine learning algorithms utilize word embeddings that map words or phrases to vectors of real numbers. In some embodiments, the embeddings serve as the input into the machine learning model. In some embodiments, the mapping is generated by a neural network. In some embodiments, a machine learning algorithm is applied to parse the text obtained from chat messages (e.g., text message or extracted text from a video or audio recording/streaming by the user). In some embodiments, a machine learning algorithm is applied to segment words into morphemes and identify the class of the morphemes. In some embodiments, a machine learning algorithm is applied to identify and/or tag the part of speech for the words in the multimedia content (e.g., tagging a word as a noun, verb, adjective, or adverb). In some embodiments, the application applies at least one machine learning algorithm to safety alert communications such as alerts, messages, requests, or chat session information to determine a type or category of safety alert type (e.g., injury or accident, medical problem, shooting, violent crime or threat, robbery, tornado, fire) and/or emergency level (e.g., safe, low, medium, high). In some embodiments, the algorithm determines an appropriate emergency dispatch center based on the safety alert data. For example, training data sets may include emergency locations and actual emergency response times for specific dispatch centers and/or first responders. For example, an actual emergency response time may be calculated based on a first time when the safety alert or communication was sent and/or received or when the first responder(s) was assigned and/or contacted regarding a safety alert and a second time when the responder(s) reached the victim or safety alert location. Accordingly, machine learning can train models that accept data inputs such as emergency location and dispatch center and/or first responder(s) (e.g., a particular police or fire station or hospital), and generate an output indicating an estimated response time. In some embodiments, the training data and/or data inputs include additional information that can influence response time such as time of the safety alert and/or level of traffic congestion (e.g., near the alert location, the responder location, or a calculated route connecting the alert and responder locations).

### Digital Processing Device

In some embodiments, the platforms, media, methods and applications described herein include a digital processing device, a processor, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected to a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, walkie talkies, radios, tablet computers, personal digital assistants, video game consoles, and vehicular consoles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD, Linux, Apple® Mac OS X Server®, Oracle® Solaris®, WindowsServer®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research. In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In some embodiments, the non-volatile memory comprises magnetoresistive random-access memory (MRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a subject. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In some embodiments, the display is E-paper or E ink. In other embodiments, the display is a video projector. In still further embodiments, the display is a combination of devices such as those disclosed herein.

In some embodiments, the digital processing device includes an input device to receive information from a subject. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, media, methods and applications described herein may include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, media, methods and applications described herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite,.NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable compiled applications.

### Software Modules

In some embodiments, the platforms, media, methods and applications described herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules include, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of barcode, route, parcel, subject, or network information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM Blackberry® Browser, Apple® Safari®, Palm® Blazer, Palm® WebOS® Browser, Mozilla Firefox® for mobile, Microsoft® Internet Explorer® Mobile, Amazon Kindle® Basic Web, Nokia® Browser, Opera Software Opera Mobile, and Sony PSP™ browser.

Those skilled in the art will recognize that a wide variety of other modifications, alterations, and combinations can also be made with respect to the above-described embodiments without departing from the scope of the disclosure, and that such modifications, alterations, and combinations are to be viewed as being within the ambit of the inventive concept.

1. A method for facilitating electronic safety alert communications by a safety alert management system, the method comprising:
receiving an electronic safety alert for a specific safety event from a user electronic device, the safety alert received at a safety alert management application and comprising at least one user message from a user associated with the user electronic device and additional user data associated with the user;
initiating a chat session between the user and a safety agent attending the safety management application, the chat session permitting exchange of text-based messages between the user and the safety agent and display of the text-based messages in a chat window of a graphical user interface accessed via the safety alert management application;
for at least one user message received at the safety management application, determining a reply message to send to the user electronic device in response to the at least one user message, wherein determining a reply message includes:
via an artificial intelligence engine associated with the safety management application, using a machine learning model trained on historical chat sessions and historical data associated with historical safety alerts to analyze the at least one user message and determine one or more recommended reply messages addressing a possible safety issue experienced by the user, at least one of the one or more recommended reply messages determined by selecting at least one relevant pre-determined reply message from a stored library of pre-determined reply messages related to various kinds of safety issues, based at least on the at least one user message,
displaying the one or more recommended reply messages on the graphical user interface; and
receiving a selection indicating an agent-selected message from the safety agent, the agent-selected message including one of the one or more recommended reply messages.

2. The method of claim 1, wherein the step of selecting at least one relevant pre-determined reply message is based at least on an entire message history of the chat session and the user data.

3. The method of claim 1, wherein initiating a chat session between the user and the safety agent includes receiving a unique identifier for the chat session, the unique identifier associating an entire message history of the chat session, the one or more recommended reply messages, the user data, and the agent-selected message together in a database; and
wherein the entire message history of the chat session, the one or more recommended reply messages, the user data, and the agent-selected message associated together via the unique identifier is used to train the machine learning model.

4. The method of claim 1, further comprising displaying the agent-selected message in a text input portion of the chat window for the chat session and permitting the safety agent to edit the agent-selected message before sending the agent-selected message to the user electronic device.

5. The method of claim 1, wherein the machine learning model determines whether to select a pre-determined reply message pertaining to the user needing on-site assistance.

6. The method of claim 1, wherein the safety management application receives location information generated by the user electronic device and the machine learning model determines the one or more recommended reply messages based at least on the location information.

7. The method of claim 6, wherein the safety management application further receives environmental data obtained by one or more environmental sensors and the machine learning model determines the one or more recommended reply messages based at least on the environmental data.

8. The method of claim 1, wherein the machine learning model is a language processing model selected from recurrent neural networks, long short-term memory networks, and transformer models.

9. The method of claim 1, wherein the machine learning model is generative pretrained transformer (GPT).

10. The method of claim 1, wherein the machine learning model determines the one or more recommended reply messages based on contextual information extracted from one or more of sensor data, camera data, emergency call data, law enforcement data, weather data, geolocation data.

11. The method of claim 1, wherein the graphical user interface includes a first selectable tab that displays a pool of the pre-determined reply messages and a second selectable tab that displays the one or more recommended reply messages.

12. A method for facilitating electronic safety communications by a safety alert management system, the method comprising:
receiving an electronic safety alert for a specific safety event from a user electronic device, the safety alert received at a safety alert management application and comprising at least one user message from a user associated with the user electronic device and additional user data associated with the user;
initiating a chat session between the user and a safety agent attending the safety alert management application, the chat session permitting exchange of text-based messages between the user and the safety agent and display of the text-based messages in a chat window of a graphical user interface accessed via the safety alert management application;
for at least one user message received at the safety management application, determining a reply message to send to the user electronic device in response to the at least one user message, wherein determining a reply message includes:
via an artificial intelligence engine associated with the safety management application, using a generative pretrained transformer (GPT) model trained on historical chat sessions and historical data associated with historical safety alerts to analyze the at least one user message and determine one or more recommended reply messages addressing a possible safety issue experienced by the user, wherein at least one of the recommended reply messages is a generated message generated by the GPT model based at least on the at least one user message;
displaying the one or more recommended reply messages on the graphical user interface; and
receiving a selection indicating an agent-selected message from the safety agent, the agent-selected message including one of the one or more recommended reply messages.

13. The method of claim 12, wherein at least one of the recommended reply messages determined by the GPT model is determined by selecting at least one relevant pre-determined reply message from a stored library of pre-determined reply messages, based at least on based at least on the at least one user message.

14. The method of claim 13, wherein displaying the one or more recommended reply messages on the graphical user interface includes indicating via at least one of color, text, or placement whether a displayed recommended reply message is one of the at least one selected pre-determined reply messages or one of the at least one generated messages.

15. The method of claim 12, wherein initiating an electronic chat session between the user and the safety agent includes receiving a unique identifier for the chat session, the unique identifier associating an entire message history of the chat session, the one or more recommended reply messages, the user data, and the agent-selected message together in a database; and
wherein the entire message history of the chat session, the one or more recommended reply messages, the user data, and the agent-selected message associated together via the unique identifier is used to train the GPT model.

16. The method of claim 12, wherein the GPT model determines the one or more recommended reply messages based at least on an entire message history of the chat session.

17. A method for training a safety chat language model in a safety alert management system, the method comprising:
inputting at least one first set of training data including a plurality of text messages related to safety events into a safety chat language model and training the safety chat language model on the at least one first set to determine relevant reply messages addressing possible safety issues described in the text messages in response to the text messages;
receiving an electronic safety alert for a specific safety event from a user electronic device, the safety alert received at a safety management application and comprising at least one user message from a user associated with the user electronic device and additional user data associated with the user;
initiating an electronic chat session for the electronic safety alert between the user and a safety agent attending the safety management application;
analyzing the at least one user message via the trained safety chat language model to determine one or more recommended reply messages, based at least on an entire message history of the chat session and the user data;
displaying the one or more recommended reply messages to the safety agent in a graphical user interface of the safety management application;
receiving a selection indicating an agent-selected message selected by the safety agent, the agent-selected message including one of the one or more recommended reply messages;
transmitting the agent-selected message to the user electronic device via the chat session;
associating the electronic safety alert, the entire history of the electronic chat session, the user data, the one or more recommended reply messages, and the transmitted agent-selected message via a unique alert identifier to provide an associated second set of training data;
inputting the associated second set of training data into the safety chat language model and training the safety chat language model thereon.

18. The method of claim 17, wherein the at least one first set of training data comprises historical chat sessions and historical data associated with historical electronic safety alerts.

19. The method of claim 17, wherein the safety chat language model determines the one or more recommended reply messages based at least in part on contextual information extracted from one or more of sensor data, camera data, emergency call data, law enforcement data, weather data, or geolocation data, and the contextual information is associated with the unique alert identifier and included in the associated second set of training data.

20. The method of claim 17, further comprising measuring one or more time periods associated with the safety alert selected from a total length of time of the chat session or a length of time between receipt of the user message and transmission of the transmitted agent-selected message in reply to the user message, associating the one or more time periods with the second set of training data via the unique alert identifier, and training the safety language model to determine subsequent recommended reply messages based on time efficiency.
